(19) United States
(12) Patent Application Publication
(10) Pub. No.: US 2007/0220506 A1
(43) Pub. Date: Sep. 20, 2007

(54) SOFTWARE UPDATE METHOD, UPDATE MANAGEMENT PROGRAM AND INFORMATION PROCESSING APPARATUS

(75) Inventor: Akiko MARUYAMA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/426,962

(22) Filed: Jun. 28, 2006

(30) Foreign Application Priority Data
Mar. 14, 2006 (JP) 2006-068912

(51) Int. Cl. G06F 9/44

(52) U.S. Cl. 717/168

(57) ABSTRACT

The present invention provides a software update method, including: a first step for detecting an execution of an update process using update information of software installed in a first nonvolatile storage medium of an electronic apparatus; and a second step for storing the update information in a second nonvolatile storage medium which is different from the first nonvolatile storage medium.

### BACKGROUND OF THE INVENTION

1. Field of the Invention

The present invention relates to a software update technique, e.g., a technique effectively applicable to a maintenance management, and a restructure of, basic software and application software which are installed in an electronic apparatus, and more specifically to a technique effectively applicable to a system restructure necessitated by virus infection, hard disk breakdown, software-induced failure, et cetera.

2. Description of the Related Art

In an electronic apparatus, for example a personal computer (PC) and an information terminal, et cetera, updates are provided at any given time for basic software such as an operating system and application software such as an application program operating under the control of the operating system for the purpose of a functional reinforcement and a security measure.

Taking advantage of a propagation of information networks such as the Internet, a practice recently becoming popular is so called an online update in which such a software update is carried out by obtaining an update module such as a program and a file that are necessary for an update from a server, which is run by the software provider, by way of the Internet.

In the meantime, an electronic apparatus sometimes needs a replacement or an initialization of a storage medium, such as hard disk in which software such as operating system and application program are installed, necessitated by a computer virus infection, a hard disk breakdown or a software-induced failure.

After installing an operating system in a replaced or initialized hard disk, all the prior updates are lost.

In order to restore the software by updating it to the latest condition, an update module (s) needs to be obtained by connecting the electronic apparatus to an information network such as the Internet.

The electronic apparatus immediately after restoring the operating system, however, is defenseless because a security measure is not yet updated and therefore is faced with a technical problem of an online update immediately after restoring the operating system being undesirable because there is a risk of a virus infection the moment the electronic apparatus is connected to the Internet.

There is another technical problem in which an online update is carried out almost automatically and therefore a user forgets a history of updates up to the latest state, resulting in an inability to manage a correct update of the software.

A patent document 1 has disclosed a technique for storing the difference between a pre- and post-updates in a history management file equipped in a nonvolatile storage medium built-in in a computer or a separate server at the time of updating a file equipped in the computer.

The technique proposed by the patent document 1, however, equips the history management file in the same storage medium as the one storing an update target file, and therefore is faced with the technical problem of the history management file being also lost by a failure or replacement of the storage medium, thus making it difficult to reproduce an update.

In the case of storing the history management file in the server, an access to an information network is required also for an update following a system restoration, and therefore a risk of a computer virus infection still remains.

Also, in the case of storing the differences between the pre- and post-updates lumped together in a single history management file, specific software for storing and restoring them is required, hence the technique lacks a freedom of restoration, or versatility.
[Patent document 1] Laid-Open Japanese Patent Application Publication No. 2004-246479 (laid open on Sep. 2, 2004)

### SUMMARY OF THE INVENTION

A purpose of the present invention is to provide a technique enabling an update of software for a failure recovery, et cetera, of an electronic apparatus without risking a security.

Another purpose of the present invention is to provide a technique enabling a simple and accurate execution of a maintenance management of software, such as restoration and update, of an electronic apparatus without making a user conscious.

Yet another purpose of the present invention is to provide a technique enabling an execution of diverse updates of software for a failure recovery, et cetera, of an electronic apparatus.

A first aspect of the present invention is to provide a software update method, including a first step for detecting an execution of an update process using update information of software installed in a first nonvolatile storage medium of an electronic apparatus; and a second step for storing the update information in a second nonvolatile storage medium which is different from the first nonvolatile storage medium.

A second aspect of the present invention is to provide the software update method according to the first aspect, wherein the second step stores, in the second nonvolatile storage medium, management information for managing the update information stored by the aforementioned second nonvolatile storage medium.

A third aspect of the present invention is to provide a software update method updating software installed in a first nonvolatile storage medium of an electronic apparatus, including: a first step for reading update information stored by a second nonvolatile storage medium which is different from the first nonvolatile storage medium; and a second step for updating the software by using the update information.

A fourth aspect of the present invention is to provide the software update method according to the third aspect, wherein the second nonvolatile storage medium accumulates the update information externally obtained by way of an information network at the time of the past online updates of the software.

A fifth aspect of the present invention is to provide a storage medium for storing an update management program to enable a computer to perform a software update method, the method comprises a first step for detecting an execution of an update process using update information of software installed in a first nonvolatile storage medium of an electronic apparatus; and a second step for storing the update information in a second nonvolatile storage medium which is different from the first nonvolatile storage medium.

A sixth aspect of the present invention is to provide the storage medium, wherein the method further comprises a third step for presenting a list of the update information stored by the second nonvolatile storage medium to a user for prompting a user selection; and a fourth step for updating the software by using the selected update information.

A seventh aspect of the present invention is to provide the storage medium, wherein the method further comprises a fifth step for moving the update information stored by the second nonvolatile storage medium to a different third nonvolatile storage medium.

An eighth aspect of the present invention is to provide the storage medium, wherein the method includes an operation for executing the update process by obtaining the update information by way of an information network in the first step.

A ninth aspect of the present invention is to provide the storage medium, wherein the method includes a process for storing, in the second nonvolatile storage medium, management information for managing the update information stored by the aforementioned second nonvolatile storage medium in the second step.

A tenth aspect of the present invention is to provide the storage medium, wherein a program code for the first and second steps is resident in a main memory of the computer.

An eleventh aspect of the present invention is to provide an information processing apparatus, including an update execution unit detecting an execution of an update process using update information of software installed in a first nonvolatile storage medium; and an update information management unit storing the update information in a second nonvolatile storage medium which is different from the first nonvolatile storage medium.

A twelfth aspect of the present invention is to provide an information processing apparatus for updating software installed in a first nonvolatile storage medium, including: an update information management unit reading update information stored by a second nonvolatile storage medium which is different from the first nonvolatile storage medium; and an update unit updating the software by using the update information.

The above described present invention for instance makes it possible to store, in a different area from the one storing an operating system, update information used for an update without making a user conscious simultaneously with an update of software of an electronic apparatus, and also make, and record, a list of what kind of updates being carried out.

This configuration enables a comprehensive updates of software offline without using an information network in a defenseless state before an update immediately after reinstalling an operating system necessitated by a failure of an electronic apparatus.

That is, it is possible to carry out an update of software in a failure recovery, et cetera, of an electronic apparatus without causing a security risk.

It is also possible to carry out a simple and accurate maintenance management such as recovery and update of software of an electronic apparatus without making a user conscious of it.

Furthermore, the present invention is configured to store a state of post-update software by separating update information into each update, instead of a lumped disk image, and therefore, an erroneous setup by a user and a defect due to a virus infection are not stored, and hence it is possible to adopt only necessary updates at the time of reinstalling an operating system.

In the event of reinstalling an operating system, updates of a driver, an application, et cetera, which are no longer used, or an update causing a defect shall be avoided.

The present invention is contrived to enable a user to select a presence or absence of update of individual update information from a display of a list of stored update information, thereby enabling a suppression of unnecessary updates.

That is, the present invention enables an execution of diverse updates of software on the basis of an intention, a software usage condition, et cetera, of the user.

### BRIEF DESCRIPTION OF THE DRAWINGS

FIG. 1 is a conceptual diagram exemplifying a configuration of an electronic apparatus being installed by an update management program embodying a software update method according to an embodiment of the present invention;

FIG. 2 is a conceptual diagram exemplifying a network environment of an electronic apparatus according to an embodiment of the present invention;

FIG. 3 is a conceptual diagram exemplifying update management information generated by an update management program according to an embodiment of the present invention;

FIG. 4 is a conceptual diagram exemplifying a recording format of a file for retaining update management information;

FIG. 5 is a conceptual diagram exemplifying a main screen of an update management program according to an embodiment of the present invention;

FIG. 6 is a conceptual diagram of an online update process in an update management program according to an embodiment of the present invention;

FIG. 7 is a flow chart of an online update process in an update management program according to an embodiment of the present invention;

FIG. 8 is a conceptual diagram exemplifying a resident monitor process of an update in an update management program according to an embodiment of the present invention;

FIG. 9 is a flow chart exemplifying a resident monitor process of an update in an update management program according to an embodiment of the present invention;

FIG. 10 is a conceptual diagram exemplifying an offline (recovery) update process in an update management program according to an embodiment of the present invention;

FIG. 11 is a flow chart exemplifying an offline (recovery) update process in an update management program according to an embodiment of the present invention;

FIG. 12 is a conceptual diagram exemplifying a movement process of an update module in an update management program according to an embodiment of the present invention; and

FIG. 13 is a flow chart exemplifying a movement process of an update module in an update management program according to an embodiment of the present invention.

### DESCRIPTION OF THE PREFERRED EMBODIMENTS

The following is a detailed description of the preferred embodiment of the present invention by referring to the accompanying drawings.

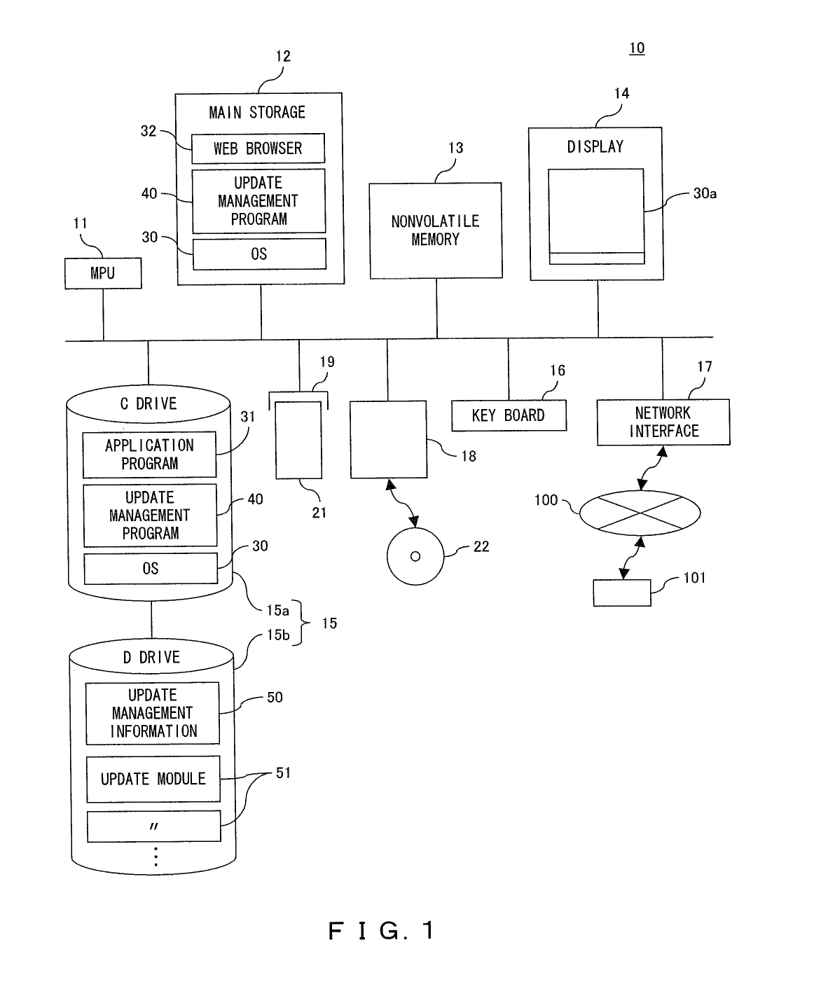

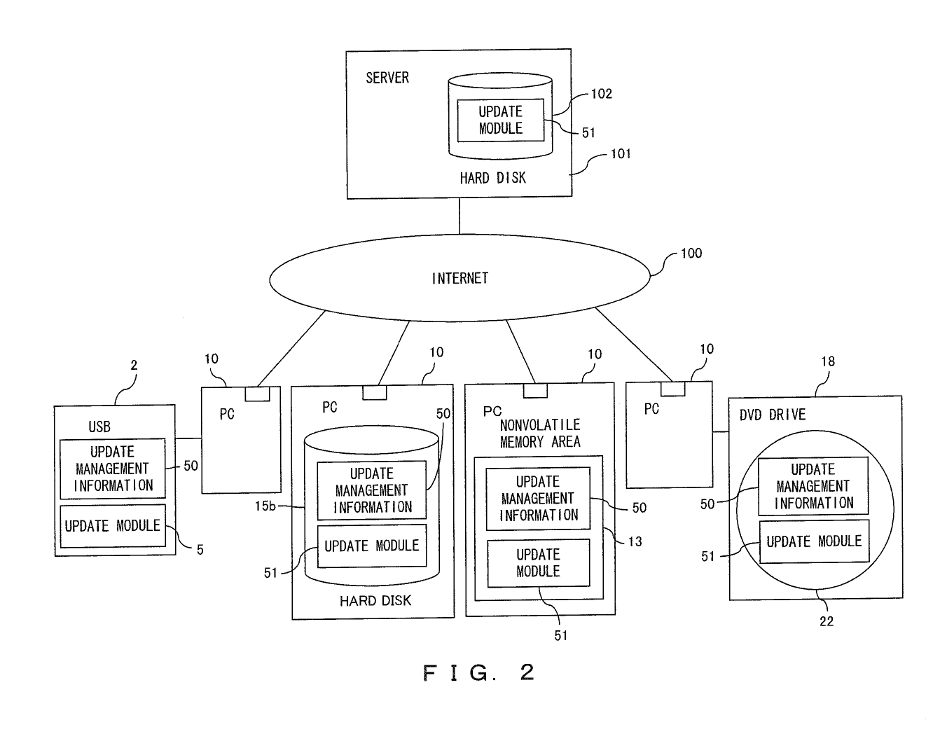

FIG. 1 is a conceptual diagram exemplifying a configuration of an electronic apparatus (i.e., an information processing apparatus) being installed by an update management program embodying a software update method according to an embodiment of the present invention; and FIG. 2 is a conceptual diagram exemplifying a network environment of an electronic apparatus according to the present embodiment.

As exemplified by FIG. 1, an electronic apparatus 10 according to the present embodiment includes a central processing unit 11, a main storage 12, built-in nonvolatile memory 13, a display 14, an external storage apparatus 15, a key board 16 and a network interface 17.

The electronic apparatus 10 according to the present embodiment can further comprise a portable media drive 18 and an extension storage slot 19 on an as required basis.

The central processing unit 11 executes software installed in the main storage 12, thereby controlling the entirety of the electronic apparatus 10 and accomplishing necessary processes.

The main storage 12 is constituted by semiconductor memory for example and stores software such as operating system 30, application program 31, et cetera.

The present embodiment is configured to store the application program 31, e.g., an update management program 40 for managing an update of software installed in the electronic apparatus 10 and Web browser 32, et cetera, as described later.

The built-in nonvolatile memory 13, being constituted by nonvolatile semiconductor memory for example, properly stores information required for a system management.

The display 14 visually presents information to a user. Later described various screens are displayed in the display 14.

The external storage apparatus 15 is constituted by a hard disk drive for example. In this case, the external storage apparatus 15 comprises a C drive 15a and a D drive 15b as physically independent storage areas.

Software, such as the operating system 30, application program 31 (e.g., an update management program 40 and Web browser 32), et cetera, are installed in the C drive 15a. These kinds of software are read by the main storage 12 and executed by the central processing unit 11 on an as required basis.

The present embodiment is configured to store update information including update management information 50, update module 51, et cetera, by the command of the update management program 40 in the D drive 15b.

The key board 16 provides the user with an information input interface for the electronic apparatus 10.

The network interface 17 provides an interface for connecting the electronic apparatus 10 to an external information network such as the Internet 100.

The portable media drive 18 records and replays information in and from a portable disk storage medium 22 including a compact disk (CD), a digital versatility disk (DVD), for example.

The extension storage slot 19, being constituted by a universal serial bus (USB) slot, is disposed for detachably attaching portable semiconductor memory 21 such as USB memory.

The operating system 30, being basic software, is executed by the central processing unit 11, thereby controlling the entirety of the electronic apparatus 10 and also provides an execution environment of the application program 31.

The Web browser 32 which is one of the application programs 31 is disposed for browsing information, and other operations, on the Internet.

The update management program 40 manages an update of software such as the operating system 30 and application program 31 which are installed in the electronic apparatus 10.

As exemplified in FIG. 2, the electronic apparatus 10 is connected to the Internet 100 by way of the network interface 17.

A server 101 is connected to the Internet 100. The server 101 comprises a storage apparatus 102 in which the update module 51 is stored.

The update module 51 means diverse kinds of information used for updating software such as binary program, binary data, text data, difference data, compression data, et cetera, which are used for updating the target software.

An update of software installed in the electronic apparatus 10 is usually carried out by obtaining an update module 51 retained by the server 101 by way of the Internet 100. Such an update of the software which is carried out by obtaining the update module 51 from the server 101 is called an online update.

The present embodiment is configured in such a manner that the update management program 40 monitors the online update, stores an update module 51 which has been used for updating individual software in a disk drive, e.g., the D drive 15b, that is different from the C drive 15a storing the operating system 30, et cetera, and manage the update module 51 by the update management information 50.

And the update management program 40 carries out an update of the software installed in the electronic apparatus 10 by using the update module 51 stored by the D drive 15b on an as required basis without accessing to the Internet 100. Such an update of the software which is carried out by the update management program 40 using the update module 51 stored by the D drive 15b without accessing to an Internet 100 is called an offline (recovery) update.

A destination of a storage for the update module 51 commanded by the update management program 40 can discretionarily designate a storage medium other than the C drive 15a in which the operating system 30 is installed.

For instance, it can designate the built-in nonvolatile memory 13 within the electronic apparatus 10 as a storage destination of the update module 51 and update management information 50.

Alternatively, if an extension storage slot 19 exists in the electronic apparatus 10, portable semiconductor memory 21 attached to the aforementioned extension storage slot 19 can be designated as the storage destination of the update module 51, et cetera.

Likewise, if a portable media drive 18 exists in the electronic apparatus 10, a portable disk storage medium 22 attached to the aforementioned portable media drive 18 can be designated as the storage destination of the update module 51, et cetera.

FIG. 2 exemplifies the electronic apparatuses 10 of a plurality of configurations showing each of the cases, as described above, designating various kinds of storage means for the electronic apparatus 10 as a storage destination of the update module 51 commanded by the update management program 40.

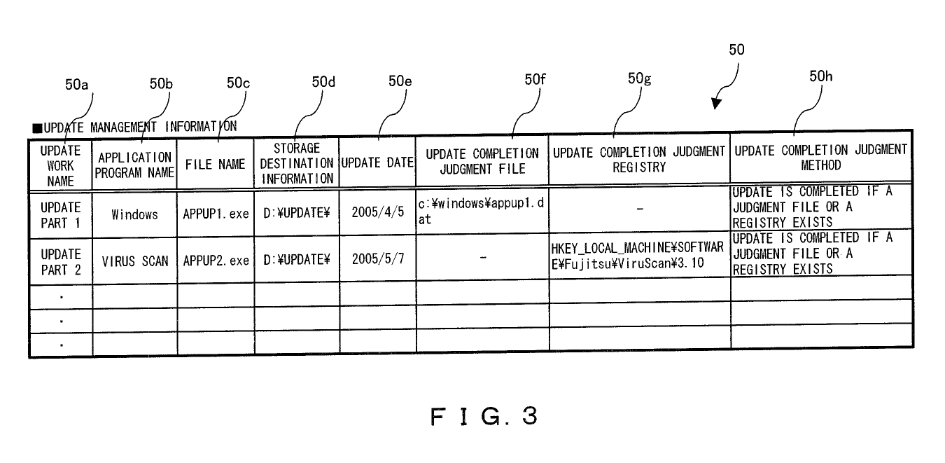

FIG. 3 is a conceptual diagram exemplifying update management information 50 generated by the update management program 40 according to the present embodiment.

The update management information 50 according to the present embodiment includes an update work name 50a, an application program name 50b, a file name 50c, storage destination information 50d, an update date 50e, an update completion judgment file 50f, an update completion judgment registry 50g and an update completion judgment method 50h.

The update work name 50a is a name invested to each update work. Each of a plurality of updates carried out for each kind of software in time series is separately managed by investing the update work name 50a with a unique name.

The application program name 50b is the name of software as the target of an update work.

The file name 50c is the file name of an update module 51 used in the update work.

The storage destination information 50d is information indicating the storage destination (e.g., the D drive 15b) of the update module 51 used in the update work.

The update date 50e is the date and time of carrying out the update work.

The update completion judgment file 50f is a file name referred to for judging whether or not the applicable update work is completed.

The update completion judgment registry 50g is information, among registry information used for the operating system 30 managing the system, indicating an item to be referred to for judging whether or not the applicable update is completed.

The update completion judgment method 50h is information of a judgment method for judging whether or not an update is completed.

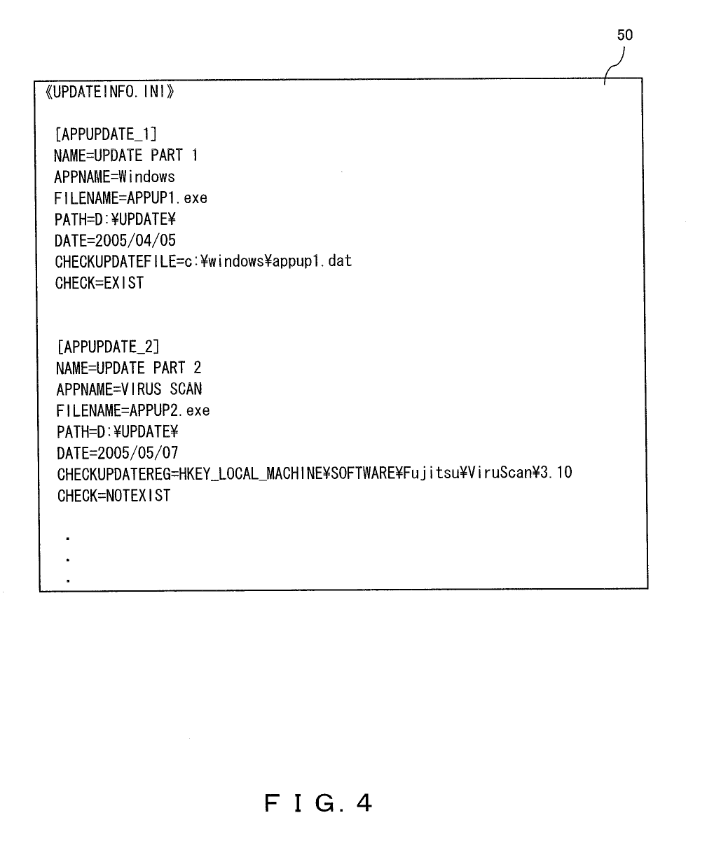

FIG. 4 is a conceptual diagram exemplifying a recording format in the case of recording information of such update management information 50 in a text file by the name of “UPDATEINFO.INI”, for example.

In the “UPDATEINFO.INI”, each update work is sectioned by a tag “[APPUPDATE_n]” and recorded in time series. The “n” in the tag is a serial number indicating a sequence of each update work.

That is, “NAME” tag is set by an update work name 50a.

“APPNAME” tag is set by an application program name 50b.

“FILENAME” tag is set by a file name 50c.

“PATH” tag is set by storage destination information 50d.

“DATE” tag is set by an update date 50e.

“CHECKUPDATEFILE” tag is set by an update completion judgment file 50f.

“CHECKUPDATEREG” tag is set by an update completion judgment registry 50g.

“CHECK” tag is set by an update completion judgment method 50h.

The following describes operations of a software update method and an update management program in the electronic apparatus 10 according to the present embodiment.

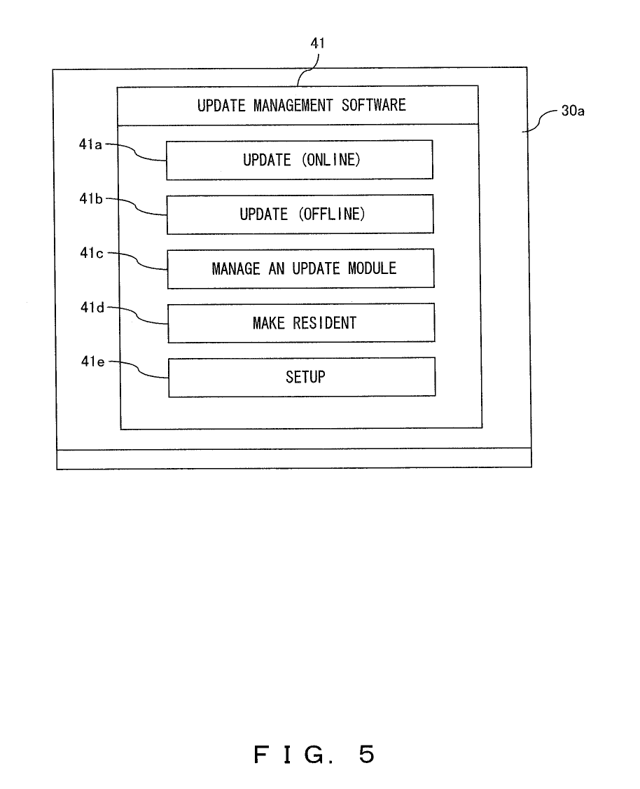

When the update management program 40 is started, a main screen 41 is displayed in an OS operation screen 30a displayed by the display 14 as exemplified by FIG. 5.

The main screen 41 is equipped with an online update button 41a, an offline update button 41b, an update module management button 41c, a resident start button 41d and an environment setup button 41e.

The online update button 41a is disposed to be pressed when an update is desired for software during a normal operation.

The offline update button 41b is disposed to be pressed when an offline update is desired without connecting to the Internet 100 after a recovery of the operating system 30 for instance.

The update module management button 41c is disposed to be pressed when a stored update module 51 is desired to be moved to another storage medium or storage apparatus.

The resident start button 41d is disposed to be pressed when making the update management program 40 resident in the main storage 12 and monitor an update.

The environment setup button 41e is disposed to be pressed when a change of a setup is desired such as a change of default storage destinations of an update module 51.

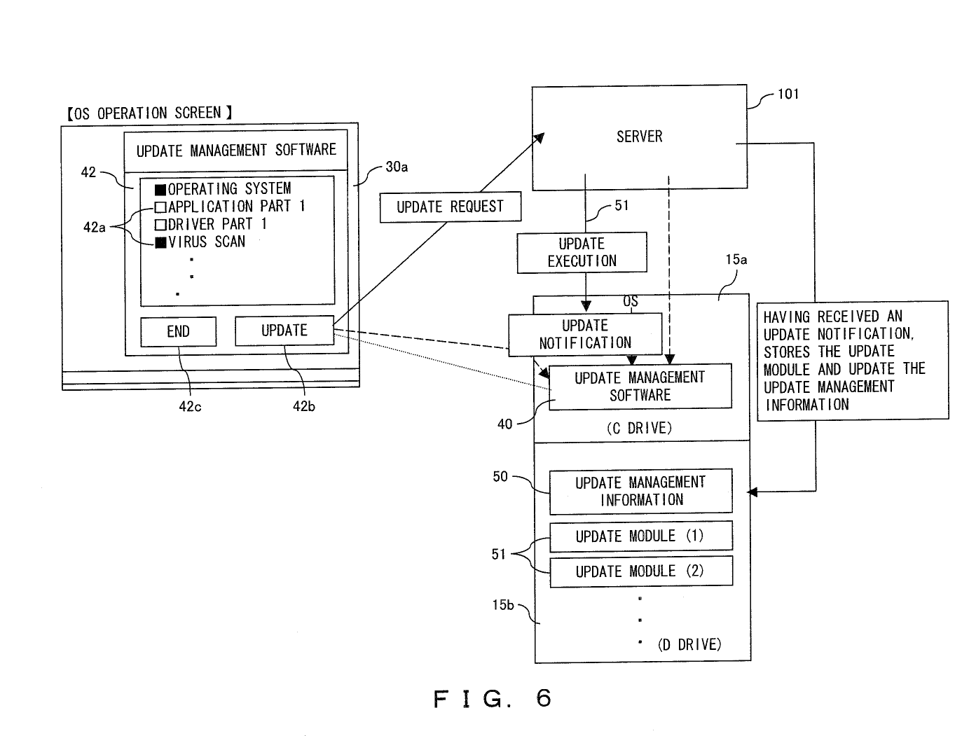

FIG. 6 is a conceptual diagram in the case of executing an online update process after pressing the online update button 41a.

By pressing the online update button 41a, the OS operation screen 30a displays an online update execution screen 42.

The online update execution screen 42 displays a list of software as the targets of updates (e.g., an operating system 30, an application program 31, a driver, a virus definition file and application data) with individual check boxes 42a.

The user checks off the check boxes 42a for specifying the update target software followed by pressing an update start button 42b to request the server 101 for an update by way of the Internet 100.

Responding to the request, an update is carried out from the server 101 by using an update module 51 for the software installed in the C drive 15a within the electronic apparatus 10.

The update management program 40 detects an execution of an update based on a pressing of the update start button 42b, an update notification from the server 101 or a notification from the operating system 30, stores the update module 51 in the D drive 15b and updates the update management information 50.

Although the storage destination of the update management information 50 and update module 51 in this event is the D drive 15b, either of the built-in nonvolatile memory 13, portable semiconductor memory 21 and disk storage medium 22 can be designated as the storage destination by an environment setup by pressing the environment setup button 41e as described above.

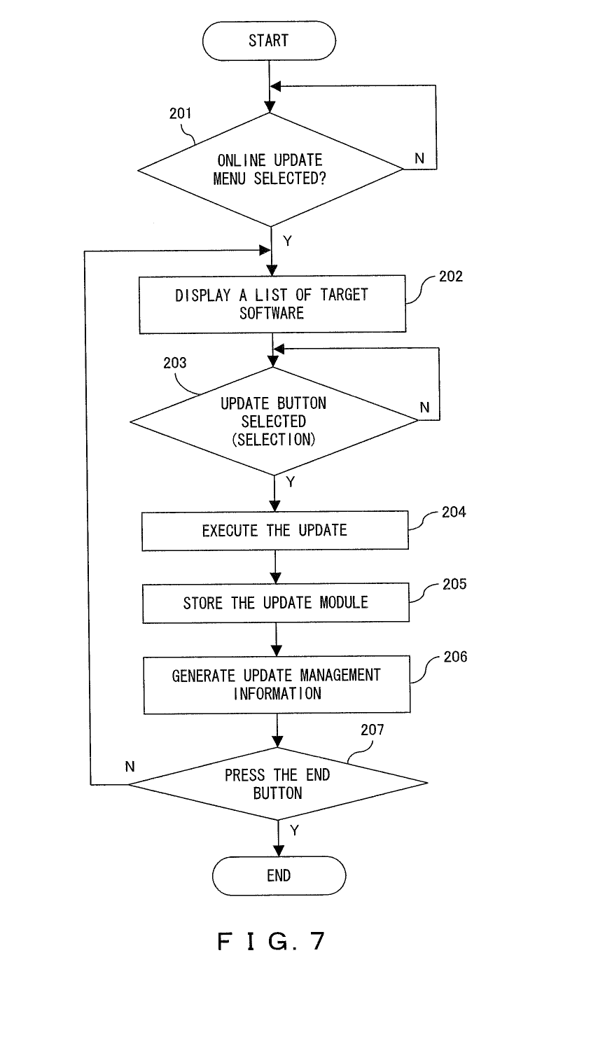

FIG. 7 is a flow chart exemplifying an online update process by such an update management program 40.

As the online update button 41a is selected (i.e., pressed) (step 201), the update management program 40 displays the main screen to make it display a list of software and lets the user select software as the target of update by the check boxes 42a (step 202).

When the update start button 42b is pressed (step 203), the update management program 40 issues a request to the server 101 for updating the software selected by the user, and carries out the update (step 204).

In this event, the update management program 40 detects an update module 51 used for the update based on a notification from the server 101 or operating system 30, and stores it in the D drive 15b that is different from the C drive 15a in which the operating system 30 is installed (step 205), followed by adding/updating the content of the corresponding update management information 50 (step 206).

This process is repeated until the user presses an end button 42c (step 207).

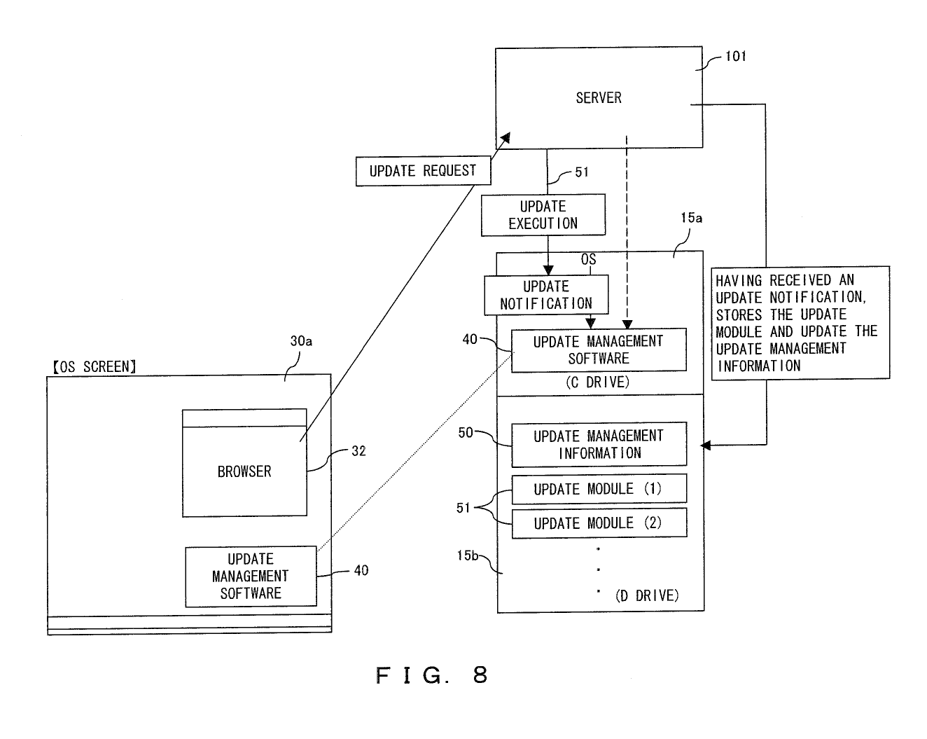

FIG. 8 is a conceptual diagram exemplifying an online update process in the case of the resident start button 41d in the above described main screen 41.

In this case, the update management program 40 is resident in a part of the main storage 12 and monitors a presence or absence of an online update of software carried out by another Web browser 32, et cetera.

Then, as an update of discretionary software installed in the C drive 15a is carried out in response to an update request from the Web browser 32 to the server 101, the information of the update execution is notified from either the server 101 or the operating system 30 to the update management program 40.

Having received the notification of the update execution, the update management program 40 acquires the update module 51 used for the aforementioned update, stores it in the D drive 15b and also updates the update management information 50 so as to record the fact of the aforementioned storing.

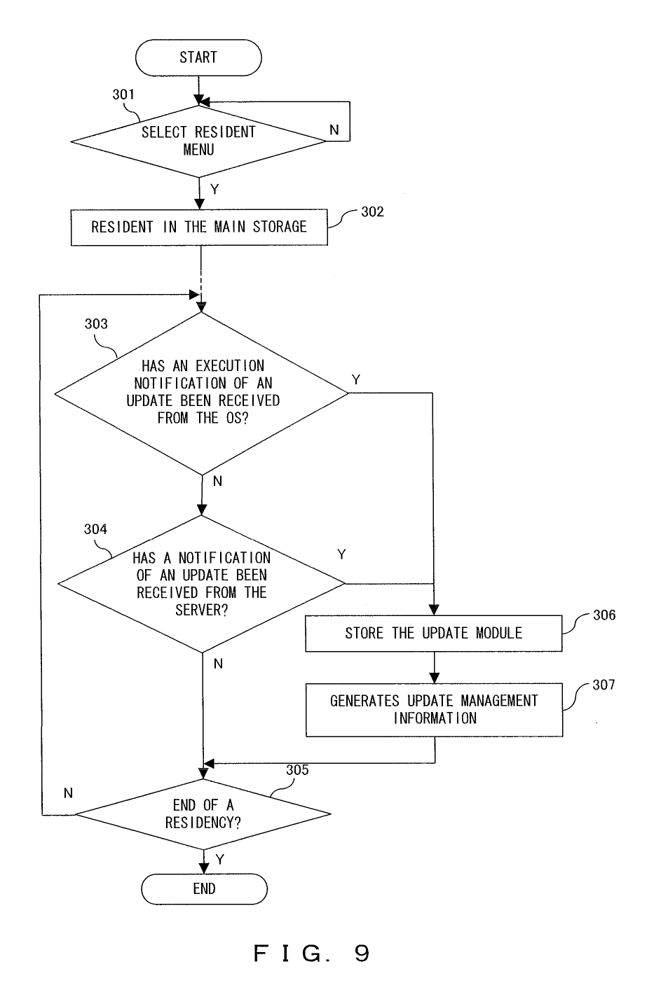

FIG. 9 is a flow chart exemplifying a monitoring of an update by the update management program 40 which is resident in the main storage 12.

In the main screen 41, as the resident start button 41d is selected (i.e., pressed) (step 301), the update management program 40 turns off the main screen 41 and resides in the main storage 12 (step 302).

And the update management program 40 monitors an occurrence of an update of discretionary software by discerning whether or not a notification of an update occurrence of discretionary software installed in the C drive 15a is received from the operating system 30 (step 303) of the server 101 (step 304).

If a notification of an update occurrence is received, the update management program 40 stores the update module 51 used for the applicable update in the D drive 15b (step 306) and generates/updates the update management information 50 (step 307). Such an update monitor process is repeated until an external instruction for ending the residency (step 305).

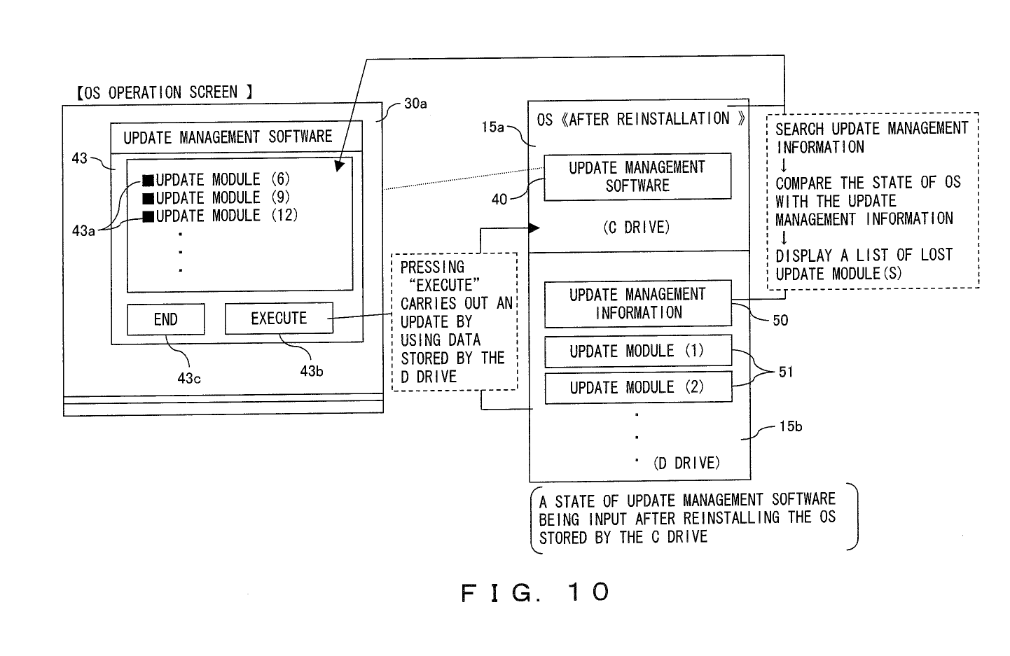

FIG. 10 is a conceptual diagram in the case of the update management program 40 carrying out an offline (recovery) update process by using an update module 51 stored by the D drive 15b in an offline update as described above.

That is, as the offline update button 41b is pressed in the above described main screen 41 of the update management program 40, an offline update execution screen 43 is displayed.

In this event, the update management program 40 examines whether or not a part of updates previously executed is lost as a result of an installation, et cetera, of the operating system 30 by collating the current state thereof with a list of the update completion judgment file 50f in the update management information 50 (i.e., the update completion judgment registry 50g).

If there is a part of updates previously executed is lost as a result of an installation of the operating system 30, the update management program 40 detects the update module(s) 51 applicable to the lost update from among a plurality of update modules 51 stored by the D drive 15b and displays it together with the check box(es) 43a in the offline update execution screen 43. In this event, all of the check boxes 43a are in a state of selection as default.

The user operates the check boxes 43a so as to remove the update module(s) 51 which seems unnecessary from among the displayed list thereof.

The user removes, for example, the update modules 51 relating to a driver program and application program which are no longer used, the one which caused a defect at a past execution of update, et cetera, among the update modules 51 displayed in a list.

Then, a pressing of an update execution button 43b of the offline update execution screen 43 carries out an offline update by using the update module(s) 51 stored by the D drive 15b.

The update management program 40 records an execution history of updates in the update management information 50 also in the offline update.

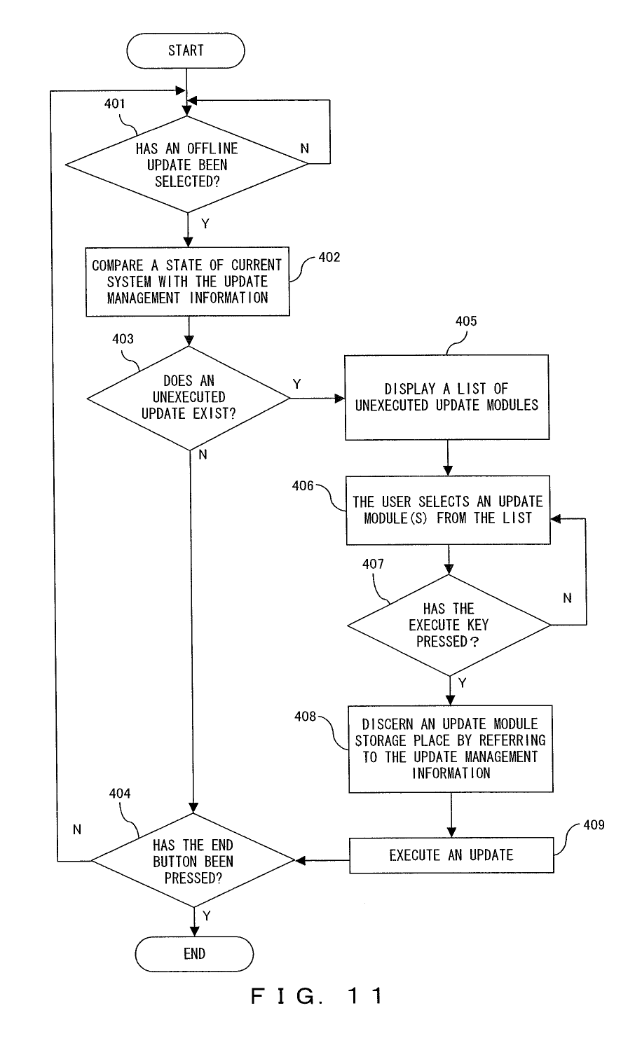

FIG. 11 is a flowchart exemplifying an offline (recovery) update process carried out by the update management program 40.

As the offline update button 41b is selected (i.e., pressed) in the main screen 41 (step 401), the update management program 40 compares a state of software such as the current operating system 30 stored by the C drive 15a with the update completion judgment file 50f or update completion judgment registry 50g (step 402), followed by discerning a presence or absence of a content of a lost update(s) as a result of reinstalling the operating system 30 (step 403).

If an update module(s) 51 relating to a lost (i.e., not yet carried out) update(s) exists, the update management program 40 displays a list of the update module(s) 51 relating to the lost (i.e., not yet carried out) update(s) in the offline update execution screen 43 (step 405). In this event, all of the check boxes 43a of the displayed update module(s) 51 are in the state of being selected.

Then the update management program 40 receives a designation of removing an update module(s) 51 which seems unnecessary from the user by operating the check box(es) 43a of the displayed list of the update module(s) 51 (step 406).

Then, when the update execution button 43b is pressed (step 407) the update management program 40 refers to the designation of the check boxes 43a, thereby recognizing the selected update module(s) 51; refers to the update management information 50, thereby discerning a storage place(s) of the relevant update module(s) 51; reads it from the storage place (i.e., the D drive 15b in this case) (step 408); and carries out an offline update(s) of the software installed in the C drive 15a (in time series) (step 409).

Then, when detecting a pressing of the end button 43c (step 404), the update management program 40 ends the offline update.

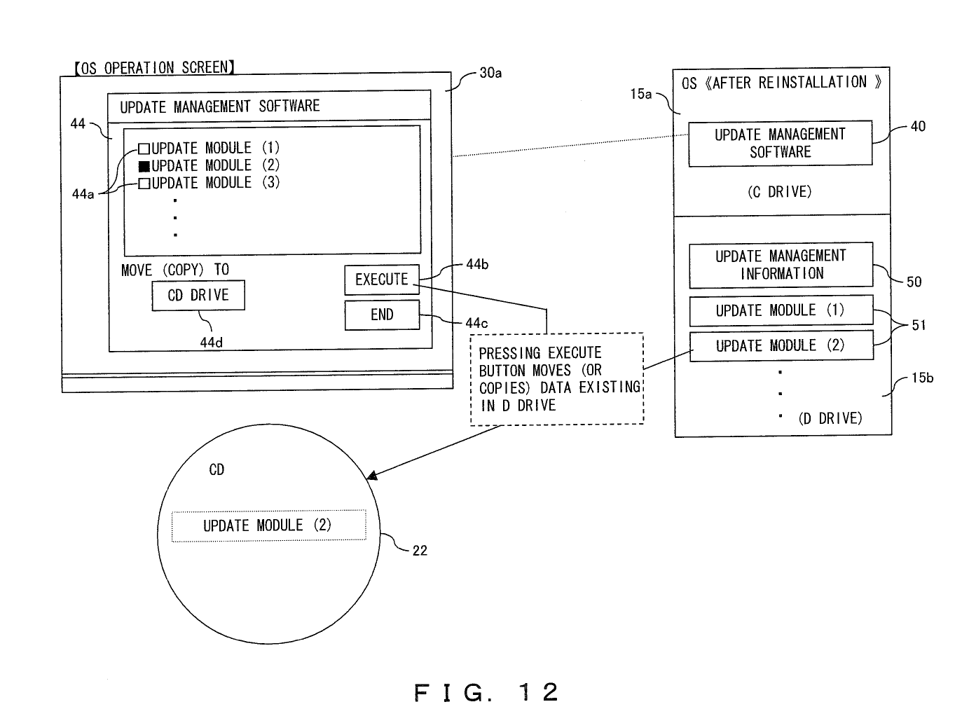

FIG. 12 is a conceptual diagram exemplifying a movement process of an update module 51 stored once by a predetermined storage medium to another storage medium by processing of the update management program 40.

The movement process is carried out by a pressing of the update module management button 41c in the main screen 41 exemplified in FIG. 5.

As the update module management button 41c is pressed, the update management program 40 displays an update module movement process screen 44.

A list of update modules 51 stored by the storage place (i.e., the D drive 15b in this case) specified by the current storage destination is displayed together with check boxes 44a in the update module movement process screen 44 as a result of referring to the update management information 50.

The user selects the update module 51 desired to be moved by operating the applicable check box 44a.

An alternative configuration may be to display a list of update management information 50 for enabling a movement if appropriate.

The update module movement process screen 44 also displays a movement destination selection button 44d for designating a storage place of a movement destination.

The user operates the movement destination selection button 44d, thereby designating one of storage places of the movement destination (e.g., the built-in nonvolatile memory 13, portable semiconductor memory 21, portable disk storage medium 22 in the case of the present embodiment).

And a pressing of a movement execution button 44b moves the update module 51 (i.e., the update management information 50) from the current storage destination (i.e., the D drive 15b) to the designated movement destination (i.e., the portable disk storage medium 22 in the example shown in FIG. 12).

Note that in the case of referring to the update management information 50 when moving an update module 51, the update management information 50 is searched by the following procedure:

A default storage place (e.g., D drive 15b) for the update modules 51, and then other drives (i.e., an E drive, followed by an F drive and so on) are searched. If a movement origin is a portable media drive, a message such as “Insert CD storing update management information” is displayed to notify the user of a medium insertion request.

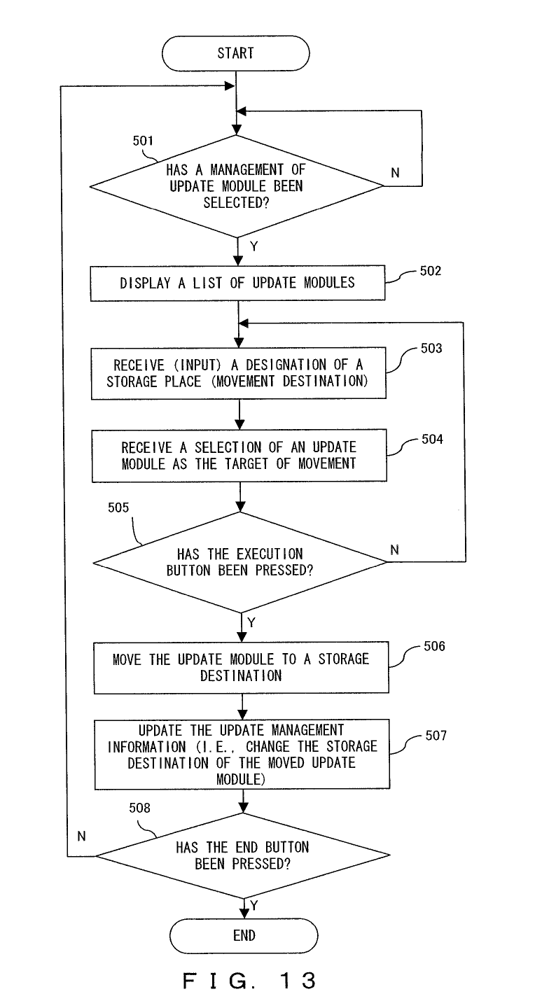

FIG. 13 is a flow chart exemplifying a movement process of an update module 51 by processing of the above described update management program 40.

As a selection (i.e., pressing) of the update module management button 41c is detected in the main screen 41 (step 501), the update management program 40 refers to the update management information 50 and displays a list of update modules 51 (including the update management information 50 on an as required basis) existing in the current storage place in the offline update execution screen 43 together with the check boxes 44a (step 502).

Then the update management program 40 receives a user's designation of a storage place of a movement destination by way of the movement destination selection button 44d (step 503).

The update management program 40 further receives the user's designation of selecting an update module(s) 51 as a result of operating the check boxes 44a of the displayed list of update modules 51 (step 504).

Then, as a pressing of the movement execution button 44b is detected (step 505), the update management program 40 moves the selected update module(s) 51 to a movement destination designated by the movement destination selection button 44d (step 506).

And it changes the storage destination information 50d in the update management information 50 to the movement destination (step 507).

The update management program 40 ends the process when the end button 44c is pressed (step 508).

As described above, the update management program 40 according to the present embodiment makes it possible to automatically store an update module 51 used for an update and the update management information 50 for managing the update module 51 in a storage place, e.g., the D drive 15b, that is different from the C drive 15a in which a system is installed, by receiving a notification from update-use software such as the operating system 30 and Web browser 32, or from the server 101, without making the user conscious when the user of the electronic apparatus 10 updates the software such as the operating system 30, application program 31, driver, virus definition file, application data, for instance.

In the case of restructuring a system such as the operating system 30 necessitated by a computer virus infection, a breakdown of the C drive 15a, a software induced failure, et cetera, in the electronic apparatus 10, the software configuring the system ends up returning to a state of pre-updates.

In this event, the present embodiment is contrived to enable an accurate restoration of a state of pre-restructure of the system by using the update management information 50 and update module 51 which are stored in the D drive 15b that is different from the C drive 15a in which the system such as the operating system 30 is installed, without accessing to the Internet 100, et cetera.

The present embodiment also displays a list of update modules 51 for prompting a user selection when restoring updates of the software following a system restructure, thereby enabling a restoration of selective updates, while avoiding an unnecessary update, and enabling various updates.

In other words, the software update method and update management program 40 according to the present embodiment are contrived to provide benefits as follows:

The capability of an offline update without accessing to the Internet 100 makes it possible to eliminate a risk of virus infections and hence secure a security because an access to the Internet 100 in a defenseless state of pre-update.

When updating normally by using the server 101, et cetera, the update module 51 and update management information 50 are automatically stored without making the user conscious, and therefore there is no risk of a missed storing.

The practice of not storing the kinds of software as the targets of updates in a whole disk image makes it possible to store only information required for updates by separating the update modules 51 from a user setup and user data which are unrelated to an update. This practice enables a restoration by reflecting only the necessary updates, without returning incorrect setups or data belonging to the user, at the time of restoring the updates, and hence the reliability of the system is improved.

The practice of not storing the kinds of software as the targets of updates in a whole disk image makes a small backup storage capacity for storing the update modules 51.

Enabling the user to select a desired update module 51 at the time of a restoration makes it possible to suppress an update using an update module 51, thereby enabling a secure prevention of a failure by such update, if the occurrence of the failure due to the aforementioned update is known.

Enabling the user to select a desired update module 51 at the time of a restoration makes it possible to accomplish a reduction of a storage capacity in the actual area of a system by avoiding an execution of updating a driver or application which is no longer used.

Note that the present invention can apparently be changed within the scope thereof, in lieu of being limited by configurations exemplified in the above described embodiment.

For instance, the present invention can be applied to a case of carrying out a normal update of software installed in the C drive 15a by using an update module 51 which is read from portable semiconductor memory 21 or a disk storage medium 22.

In such a case, the update management program 40 detects the normal update using the portable semiconductor memory 21 or disk storage medium 22 and stores the update module 51 used for the aforementioned update in a predetermined storage place, e.g., the D drive 15b, et cetera. Then, it uses the stored update module 51 at the time of an offline (recovery) update.

The present invention enables an execution of an update of software for a failure recovery, et cetera, of an electronic apparatus, without risking a security.

It also enables an execution of a simple and accurate maintenance management of software, e.g., a recovery and update, of an electronic apparatus without making a user conscious.

It also enables an execution of various updates of software for a failure recovery, et cetera, of an electronic apparatus.

What is claimed is:

1. A software update method, including:
a first step for detecting an execution of an update process using update information of software installed in a first nonvolatile storage medium of an electronic apparatus; and
a second step for storing the update information in a second nonvolatile storage medium which is different from the first nonvolatile storage medium.

2. The software update method according to claim 1, wherein
said second step stores, in said second nonvolatile storage medium, management information for managing said update information stored by the aforementioned second nonvolatile storage medium.

3. The software update method according to claim 1, wherein
said software is constituted by at least either of basic software for controlling said electronic apparatus and application software operating under a command of the basic software.

4. The software update method according to claim 1, wherein
said first step imports said update information to said electronic apparatus by way of an information network.

5. The software update method according to claim 1, including
a third step for moving said update information stored by said second nonvolatile storage medium to a separate third nonvolatile storage medium.

6. A software update method updating software installed in a first nonvolatile storage medium of an electronic apparatus, including:
a first step for reading update information stored by a second nonvolatile storage medium which is different from the first nonvolatile storage medium; and
a second step for updating the soft ware by using the update information.

7. The software update method according to claim 6, wherein
said second nonvolatile storage medium accumulates said update information externally obtained by way of an information network at the time of the past online updates of said software.

8. The software update method according to claim 6, wherein
said second nonvolatile storage medium stores management information for managing a history of updates of said software, which have been executed by using said update information accumulated in the aforementioned second nonvolatile storage medium,
said first step generates a list of the update information existing in the second nonvolatile storage medium based on said management information, presents it to a user and selectively reads, from the second nonvolatile storage medium, the update information selected by the user, and
said second step records, in the management information, a history of updates of the software, which have been executed by using the update information selectively read.

9. A storage medium for storing an update management program to enable a computer to perform a software update method, said method comprising:
a first step for detecting an execution of an update process using update information of software installed in a first nonvolatile storage medium of an electronic apparatus; and
a second step for storing the update information in a second nonvolatile storage medium which is different from the first nonvolatile storage medium.

10. The storage medium according to claim 9, wherein said method further comprises
a third step for presenting a list of said update information stored by said second nonvolatile storage medium to a user for prompting a user selection; and
a fourth step for updating said software by using the selected update information.

11. The storage medium according to claim 9, wherein said method further comprises
a fifth step for moving said update information stored by said second nonvolatile storage medium to a different third nonvolatile storage medium.

12. The storage medium according to claim 9, wherein said method includes an operation for executing said update process by obtaining said update information by way of an information network in said first step.

13. The storage medium according to claim 9, wherein said method includes a process for storing, in said second nonvolatile storage medium, management information for managing said update information stored by the aforementioned second nonvolatile storage medium in said second step.

14. The storage medium according to claim 9, wherein a program code for said first and second steps is resident in a main memory of the computer.

15. An information processing apparatus, including:
an update execution unit detecting an execution of an update process using update information of software installed in a first nonvolatile storage medium; and
an update information management unit storing the update information in a second nonvolatile storage medium which is different from the first nonvolatile storage medium.

16. The information processing apparatus according to claim 15,
storing, in said second nonvolatile storage medium, management information for managing said update information stored by the aforementioned second nonvolatile storage medium.

17. The information processing apparatus according to claim 15, wherein
said software is constituted by at least either of basic software for controlling said electronic apparatus and application software operating under a command of the basic software.

18. The information processing apparatus according to claim 15,
obtaining said update information by way of an information network.

19. The information processing apparatus according to claim 15, wherein
said update information management unit moves said update information stored by said second nonvolatile storage medium to another third nonvolatile storage medium.

20. An information processing apparatus for updating software installed in a first nonvolatile storage medium, including:
an update information management unit reading update information stored by a second nonvolatile storage medium which is different from the first nonvolatile storage medium; and
an update unit updating the software by using the update information.

21. The information processing apparatus according to claim 20, wherein
said second nonvolatile storage medium accumulates said update information externally obtained by way of an information network at the time of the past online updates of said software.

22. The information processing apparatus according to claim 20, wherein
said second nonvolatile storage medium stores management information for managing a history of updates of said software, which have been executed by using said update information accumulated in the aforementioned second nonvolatile storage medium;
said update information management unit generates a list of the update information existing in the second nonvolatile storage medium based on the management information, presents it to a user and selectively reads, from the second nonvolatile storage medium, the update information selected by the user; and
records, in the management information, a history of updates of the software, which have been executed by said update unit using the update information selectively read.
